(19) United States
(12) Patent Application Publication
(10) Pub. No.: US 2025/0039102 A1
(43) Pub. Date: Jan. 30, 2025

(54) UNIFIED DATA TRAFFIC MANAGEMENT LAYER FOR AUTONOMOUS VEHICLE

(71) Applicant: Nuro, Inc., Mountain View, CA (US)

(72) Inventors: Yuanfeng Peng, Sunnyvale, CA (US); Yichao (Roger) Shen, Mountain View, CA (US); Yu Tong (Julia) Zhang, San Mateo, CA (US)

(21) Appl. No.: 18/778,530

(22) Filed: Jul. 19, 2024

Related U.S. Application Data
(60) Provisional application No. 63/528,993, filed on Jul. 26, 2023.

(51) Int. Cl. H04L 47/2441

(52) U.S. Cl. CPC H04L 47/2441

(57) ABSTRACT

According to one aspect, a method of classifying packets includes obtaining at least a first packet on a traffic management arrangement, the traffic management arrangement being implemented on a vehicle, the vehicle including a modem arrangement that includes at least a first modem, wherein obtaining the first packet includes obtaining the first packet from a system onboard the vehicle. The method also includes classifying the first packet using the traffic management arrangement to create a first classified packet, identifying a first quality of service (QoS) tier of a plurality of QoS tiers for the first classified packet, providing the first classified packet with information that identifies the first QoS tier, and providing the first classified packet to the modem arrangement for transmission to a network based on the first QoS tier.

### PRIORITY CLAIM

This patent application claims the benefit of priority under 35 U.S.C. § 119 to U.S. Provisional Patent Application No. 63/528,993, filed Jul. 26, 2023, and entitled “UNIFIED DATA TRAFFIC MANAGEMENT LAYER FOR AUTONOMOUS VEHICLE,” which is incorporated herein by reference in its entirety.

### TECHNICAL FIELD

This patent application claims the benefit of priority under 35 U.S.C. § 119 to U.S. Provisional Patent Application No. 63/528,993, filed Jul. 26, 2024, and entitled “UNIFIED DATA TRAFFIC MANAGEMENT LAYER FOR AUTONOMOUS VEHICLE,” which is incorporated herein by reference in its entirety.

### BACKGROUND

Autonomous vehicles generally collect data while operating. The data that is collected may need to be provided to, as for example offloaded to, an external system such as a computing system that is part of a fleet management system. For example, an autonomous vehicle may collect video data while operating, and the video data may need to be provided to a computing system that is not onboard the vehicle, e.g., is offboard. The data or traffic provided by an autonomous vehicle to an external system may be voluminous and, as such, the certain types of traffic are prioritized for transmission over a network. Because network communication channels between a vehicle and a network such as the Internet are generally shared by different workloads, it is critical to substantially ensure that the highest priority traffic is provided to the network communication channels prior to providing lower priority traffic.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of a traffic management arrangement and a modem arrangement, e.g., traffic management arrangement 344 and modem arrangement 346 of FIG. 3, in accordance with an embodiment.

FIG. 5A is a diagrammatic representation of data traffic flowing through a traffic control policy arrangement, e.g., traffic control policy arrangement 458 of FIG. 4, in accordance with an embodiment.

FIG. 5B is a diagrammatic representation of classified packets flowing through a modem, e.g., classified packets 560a‘-n’ of FIG. 5A flowing through modem 346a of FIG. 4, in accordance with an embodiment.

FIG. 6 is a process flow diagram which illustrates a method of classifying packets in accordance with an embodiment.

FIG. 7 is a process flow diagram which illustrates a method of providing classified packets to a modem arrangement based on tiers, e.g., step 625 of FIG. 6, in accordance with an embodiment.

FIG. 8 is a process flow diagram which illustrates a method of operating a policy daemon in accordance with an embodiment.

FIG. 9 is a process flow diagram which illustrates a method of configuring a traffic management system on a vehicle in accordance with an embodiment.

FIG. 10 is a diagrammatic representation of a main compute with a traffic management system that facilitates the allocation of network resources for different applications executing on the main compute in accordance with an embodiment.

FIG. 11 is a process flow diagram which illustrates a method of categorizing or grouping packets into one of four quality of service (QoS) tiers in accordance with an embodiment.

### DESCRIPTION OF EXAMPLE EMBODIMENTS

### General Overview

In one embodiment, a method of classifying packets includes obtaining at least a first packet on a traffic management arrangement, the traffic management arrangement being implemented on a vehicle, the vehicle including a modem arrangement that includes at least a first modem, wherein obtaining the first packet includes obtaining the first packet from a system onboard the vehicle. The method also includes classifying the first packet using the traffic management arrangement to create a first classified packet, identifying a first quality of service (QoS) tier of a plurality of QoS tiers for the first classified packet, providing the first classified packet with information that identifies the first QoS tier, and providing the first classified packet to the modem arrangement for transmission to a network based on the first QoS tier.

In another embodiment, a vehicle includes a chassis, a modem arrangement, at least a first system, and a traffic management arrangement. The modem arrangement includes a plurality of modems and is configured to enable the vehicle to communicate with a network. The traffic management arrangement including logic encoded in one or more tangible non-transitory, computer-readable media for execution and when executed operable to obtain at least a first packet from the first system, classify the first packet to create a first classified packet, identify a first QoS tier of a plurality of QoS tiers for the first classified packet, provide the first classified packet with information that identifies the first QoS tier, and provide the first classified packet to the modem arrangement for transmission to the network based on the first QoS tier.

According to still another embodiment, a vehicle includes a chassis, a modem arrangement that is configured to communicate with a network, a plurality of systems, and a traffic management arrangement. The modem arrangement, the plurality of systems, and the traffic management arrangement are carried on the chassis. The modem arrangement includes a plurality of modems, and the plurality of systems includes a first system configured to provide a first packet of data. The traffic management system includes a packet intelligence and distribution arrangement, a real-time state arrangement, a routing rule arrangement, and a traffic control policy arrangement. The packet intelligence and distribution arrangement is configured to obtain the first packet of data from the first system and to identify contents of the first packet of data to enable the first packet of data to be prioritized for distribution by the modem arrangement. The real-time state arrangement is configured to identify a state of the vehicle. The routing rule arrangement is configured to update at least one routing rule for the vehicle based on the state. The traffic control policy arrangement is configured to update at least one traffic control policy for the vehicle based on the state. The routing rule and the traffic control policy determine how the first packet of data is to be provided to the modem arrangement for distribution.

A traffic management arrangement or layer on an autonomous vehicle is configured to substantially ensure that higher priority traffic may be delivered to an external system using a network communication channel. Higher priority traffic is generally traffic which is critical with respect to the safe operation of the autonomous vehicle. A traffic management arrangement may define and substantially enforce quality of service (QoS) tiers for different applications and traffic types, and may also dynamically update rules and policies as appropriate to substantially enforce QoS tiers.

### Description

As an autonomous vehicle operates, the autonomous vehicle may collect data, e.g., data captured by sensors onboard the autonomous vehicle, that relates to the environment around the autonomous vehicle and/or log data that indicates states and situations associated with the operation of the autonomous vehicle. Network communication channels such as cellular network communication channels between the vehicle and a network, e.g., between onboard systems of the vehicle and the Internet, are shared by substantially all workloads associated with the vehicle. Some of the data may be bandwidth-bound, some of the data may be latency-sensitive, and some of the data may be both bandwidth-bound and latency-sensitive. The underlying networks for communications channels may be subject to relatively large performance variations and, as such, may be unreliable. For example, issues that affect the performance of the underlying networks include, but are not limited to including, a relatively high traffic load and a relatively slow or unpassable path. Hence, when issues arise on a network, the ability to manage data contained in network traffic is critical to ensure that the most critical network is delivered before less critical traffic is delivered. Delivering traffic that is considered to be critical before delivering less critical traffic when a network is degraded increases the ability for a vehicle to operate safely.

In one embodiment, a traffic management system or arrangement is present on an autonomous vehicle, and is arranged to determine and to implement routing rules and traffic control policies which classify different types of traffic into quality of service (QoS) tiers such that higher priority traffic may be provided to one or more modems before lower priority traffic is provided to the one or more modems. When QoS tiers are identified for classified packets, each classified packet may be marked to identify the tier in which the classified packet belongs such that the routing of the packets may be facilitated.

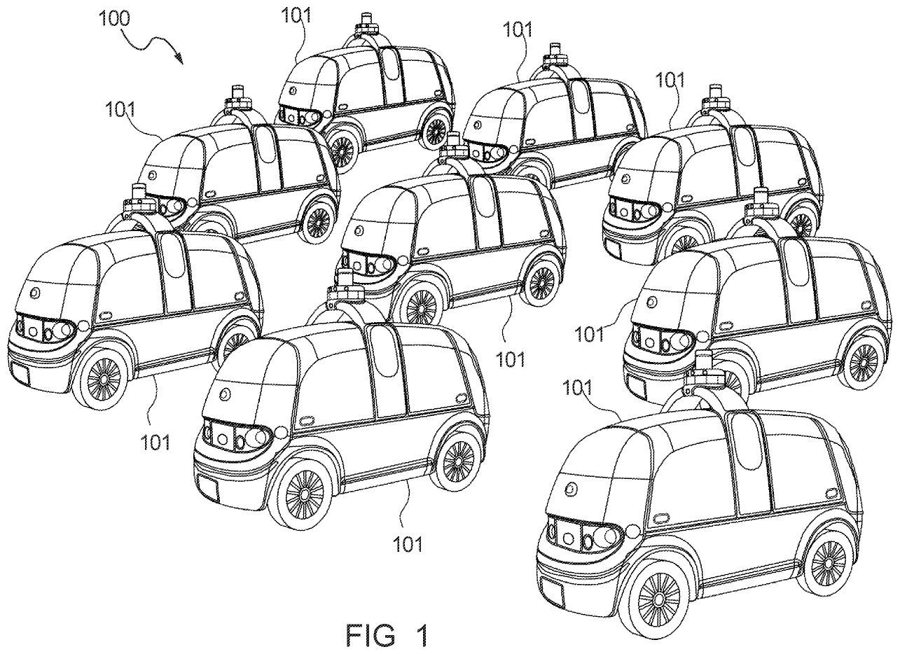

An autonomous vehicle that includes a traffic management system may generally be part of a fleet of autonomous vehicles. One or more vehicles in the autonomous vehicle fleet may include a traffic management system. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

While autonomous vehicles 101 are shown as being arranged to transport cargo, items, and/or goods, autonomous vehicle fleet 100 may also include autonomous vehicles (not shown) which are arranged to transport passengers. Autonomous vehicles which are arranged to transport passengers may also include traffic management systems.

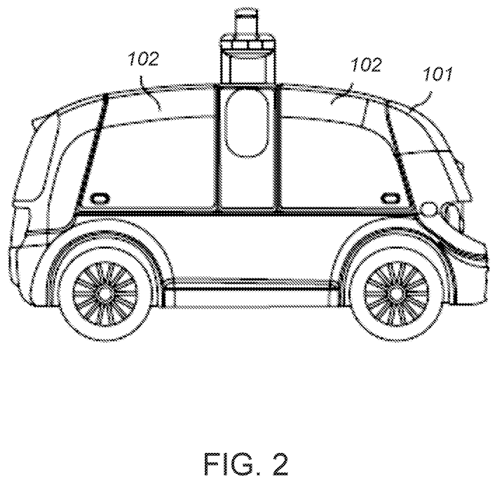

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

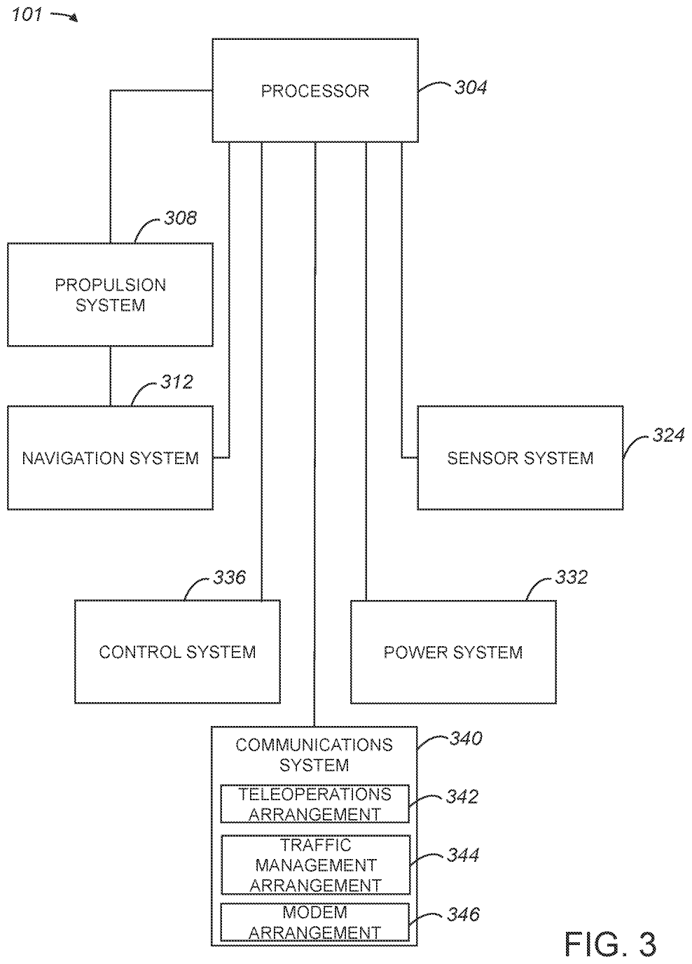

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. In the described embodiment, communications system 340 includes a teleoperations arrangement 342 that enables a teleoperations system of a fleet management system (not shown) to interact with vehicle 101 to effectively control vehicle 101, e.g., to remotely operate vehicle 101. Communications system 340 generally obtains or receives data, stores the data, and transmits or provides the data to a fleet management system (not shown) and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

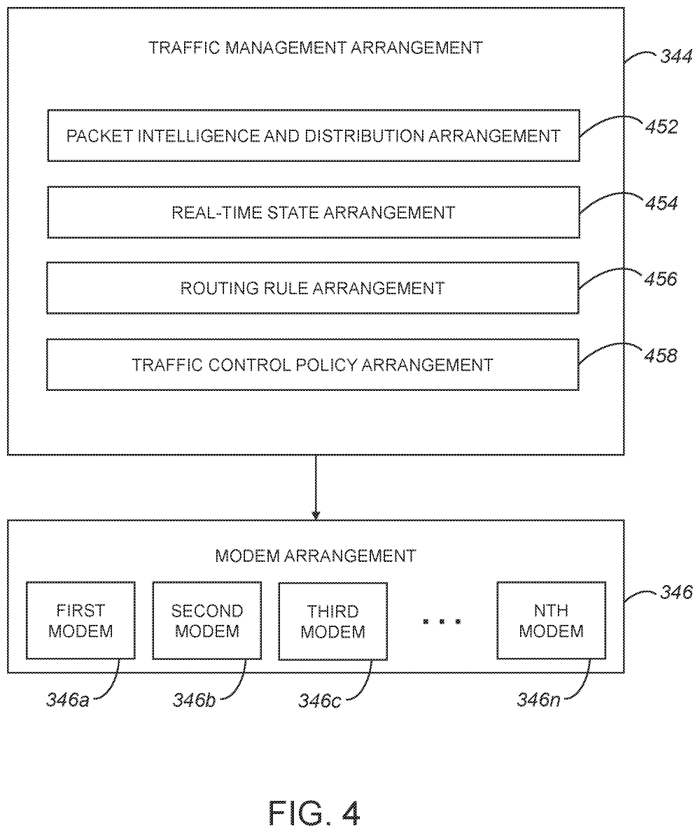

Communications system 340 also includes a traffic management arrangement 344 and a modem arrangement 346. Traffic management arrangement 344 is generally arranged to categorize packets obtained by and/or produced by vehicle 101 and to substantially group the categorized packets into tiers. Traffic management arrangement 344, which will be discussed in more detail below with respect to FIG. 4, generally manages the quality of service for outgoing data from vehicle 101, and may enable parameters or characteristics including, but not limited to including, latency sensitivity, bandwidth sensitivity, and/or traffic burstiness to be factored into determining how to manage the quality of service for the outgoing data. Modem arrangement 346 includes one or more modems which enable outgoing data to be communicated from vehicle 101 to a destination, e.g., a teleoperations system of a fleet management system (not shown), as will be discussed below with reference to FIG. 4.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

Referring next to FIG. 4, traffic management arrangement and modem arrangement 346 will be described in accordance with an embodiment. Traffic management arrangement 344, which may be implemented to include hardware and/or software, is generally arranged to exchange information with modem arrangement 346. For example, packets of data or data traffic may be provided by traffic management arrangement 344 to modem arrangement 346. In one embodiment, traffic management arrangement 344 is arranged to support egress traffic from onboard vehicle 101 to an external system, e.g., a teleoperations system.

Traffic management arrangement 344 includes a packet intelligence and distribution arrangement 452, a real-time state arrangement 454, a routing rule arrangement 456, and a traffic control policy arrangement 458. Modem arrangement 346 includes one or more modems 346a-n. In the described embodiment, modem arrangement 346 may include approximately four modems 346a-n, although it should be understood that modem arrangement 346 may include fewer than or more than four modems 346a-n.

Packet intelligence and distribution arrangement 452 is arranged to obtain data, or packets of data, from systems onboard vehicle 101. For example, packet intelligence and distribution arrangement 452 may obtain data from sensors and metrics from systems on vehicle 101. Packet intelligence and distribution arrangement 452 may generally determine the contents of packets to enable the packets to be prioritized for distribution. Packet intelligence and distribution arrangement 452 may mark or flag each packet to effectively identify the type of data contained therein. In general, packet intelligence and distribution arrangement 452 supports the management of egress or outbound traffic from vehicle 101, supports the definition and enforcement of QoS tiers for applications and traffic types supported by vehicle 101, and/or allows for the collection of network usage metric for substantially all traffic at a per application or per QoS tier granularity.

Real-time state arrangement 454 is arranged to identify system states, e.g., network metrics and/or drive-by-wire states, substantially in real-time. The state information may be used by routing rule arrangement 456 and traffic control policy arrangement 458 to essentially update routing rules and/or traffic control policies, respectively, as appropriate.

Routing rule arrangement 456 and traffic control policy arrangement 458 are configurable. Routing rule arrangement 456 is generally arranged to determine how packets are to be routed, and may determine how packets are to be routed based on the types of data contained in the packets. In one embodiment, routing rule arrangement 456 may be a Linux routing rule arrangement. It should be appreciated that routing rules associated with routing rule arrangement 456 may be configurable. Generally, a routing rule which specifies which modem particular packets may be distributed or otherwise provided to may be determined by an algorithm. For example, a Linux kernel may be leveraged by binding to different interfaces which may include one or more virtual interfaces that may allow a packet to be routed to a designated interface that is selected by an algorithm, and by identifying a kernel QoS that substantially achieves a correct and/or desired packet priority. In one embodiment, routing rule arrangement 456 may determine which modem 346a-n of modem arrangement 346 is to be used as a substantially default modem for sending outgoing traffic.

Traffic control policy arrangement 458 is arranged to substantially aggregate packets containing data of the same priority, and to determine tiers or priorities associated with each type of data. Traffic control policy arrangement 458 may generally control traffic such that the QoS for each type of traffic may effectively be met. In one embodiment, traffic control policy arrangement 458 may be a Linux traffic control policy arrangement. In general, one or more traffic control policies associated with traffic policy control arrangement 458 may be configurable. Each packet contained in the traffic is marked such that priority of data or information contained in the packet is identified, and traffic control policy arrangement 458 determines or otherwise identifies which priority tier, e.g., QoS tier, each packet belongs in. Packets that are classified by traffic control policy arrangement 458 may be provided to modem arrangement 346.

Each modem 346a-n may generally be a cellular modem. In one embodiment, each modem 346a-n may be associated with a different cellular service provider and may effectively be one or more communication channels. It should be appreciated, however, that at least some modems 346a-n may be associated with the same cellular service provider. Each modem 346a-n may have a network interface which is arranged to provide classified packets, e.g., packets classified by traffic management arrangement 344, to an external system via a network based on the tier or the QoS associated with each of the classified packets. While each modem 346a-n may have a QoS queue and a corresponding traffic interface for each QoS, or each QoS tier, associated with vehicle 101, QoS queues may instead be implemented by traffic control policy arrangement 458. In one embodiment, packets may be classified into approximately four tiers and, hence, each modem 346a-n may have approximately four queues. It should be appreciated, however, that the number of tiers and the number of QoS queues for each modem 346a-n may vary. The QoS tiers may each have a substantially default priority or level of importance. As will be discussed below, when a vehicle is not in a supervised state, e.g., not being monitored or controlled using a teleoperations system, packets classified as being in a QoS tier with a substantially default lower priority may be prioritized for transmission before packets classified as being in a QoS tier with a substantially default .higher priority.

The number of modems 346a-n may vary widely. In addition, the number of cellular providers or carriers associated with modems 346a-n may vary widely. For example, modems 346a-n may be associated with between approximately one carrier and approximately “n” carriers. In one embodiment, modems 346a-n may include approximately four modems that are associated with approximately three carriers. In such an embodiment, two modems associated with a substantially strongest and/or most reliable carrier increases hardware redundancy and provides additional bandwidth from the strongest carrier and/or most reliable carrier. Further, the use of two modems with the strongest and/or most reliable carrier enables tolerance of modem failures that are not related to the carrier. It should be appreciated that the choice of which carrier to associate with multiple modems may be based on the historical performance of substantially all carriers under consideration to effectively maximize the benefits or returns for providing redundancy.

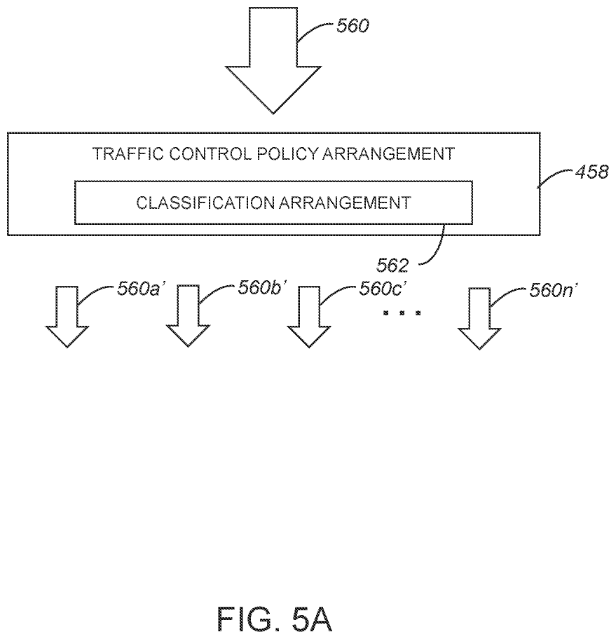

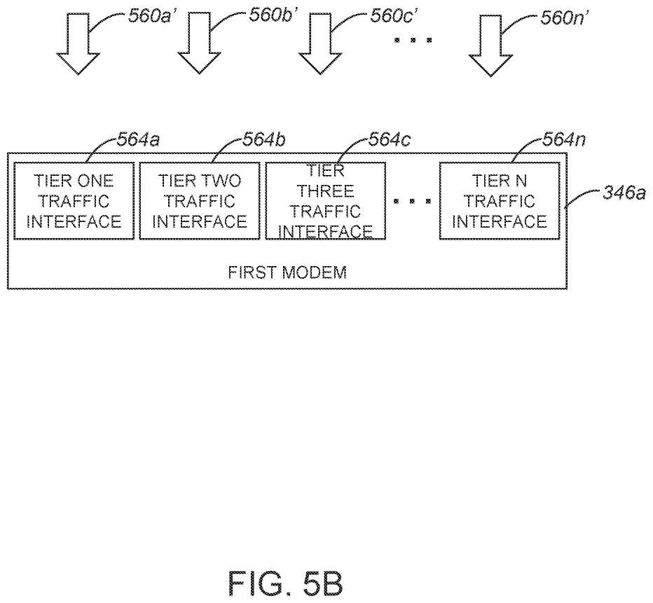

FIG. 5A is a diagrammatic representation of data traffic flowing through a traffic control policy arrangement, e.g., traffic control policy arrangement 458 of FIG. 4, in accordance with an embodiment. Traffic control policy arrangement 458 includes a classification arrangement 562 that is configured to obtain packets 560 and to substantially classify packets 560 into classified packets 560a‘-n’. Classification arrangement 562 may identify a suitable number of tiers, e.g., QoS tiers, associated with packets 560 and substantially partition or group classified packets 560a‘-n’ into the tiers. For example, classification arrangement 562 may determine that there are “n” tiers and identify a suitable tier for each classified packet 560a‘-n’. In one embodiment, classified packets 560a‘-n’ may each be marked to identify a QoS tier that classified packets 560a‘-n’ belong to.

Classified packets 560a‘-n’ may generally be provided by traffic control policy arrangement 458 to modem arrangement 346 of FIG. 4. With reference to FIG. 5B, the flow of classified packets 560a‘-n’ through a modem, e.g., modem 346a of FIG. 4, will be discussed in accordance with an embodiment. For ease of illustration, modem 346a is described as receiving or otherwise obtaining classified packets 560a‘-n’, although it should be appreciated that classified packets 560a‘-n’ are generally provided to any number of modems included in modem arrangement 346 of FIG. 4.

Modem 346a includes interfaces 564a-n which are each associated with a tier. In the embodiment as shown, classified packets 560a′ may be classified in a first QoS tier and are provided to tier one traffic interface 564a, classified packets 560b′ may be classified in a second QoS tier and are provided to tier two traffic interface 564b, classified packets 560c′ may be classified in a third QoS tier and are provided to tier one traffic interface 564c, and classified packets 560n′ may be classified in an Nth QoS tier and are provided to tier N traffic interface 564n. The number of interfaces 564a-n may generally vary widely.

Traffic interfaces 564a-n may be indicative of types of data, as types of data may be associated with different QoS tiers. That is, each traffic interface 564a-n may be arranged to handle different types of data, or different classified packets 560a‘-n’. A substantially highest tiered network interface, as for example network traffic interface 564a, may be configured to queue and or to provide classified packets 560a′ to a network. Classified packets 560a′ may include bandwidth-bound and latency-sensitive data relating to teleoperations traffic, e.g., video data. Classified packets 560b′ may include latency-sensitive data relating to teleoperations traffic, e.g., control messages, and other latency-sensitive data such as heartbeats. Classified packets 560c′ may include bandwidth-bound data that does not relate to teleoperations traffic, e.g., log snapshots. Classified packets 560d′ may include non-bandwidth-bound and non-latency-sensitive data such as, for example, textual logs for use with analysis and debugging.

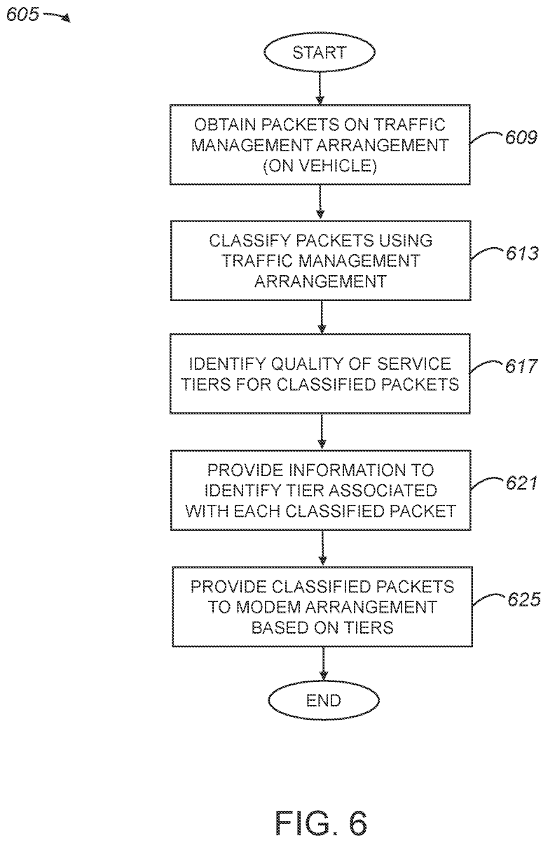

FIG. 6 is a process flow diagram which illustrates a method of classifying packets using a traffic management arrangement onboard a vehicle in accordance with an embodiment. A method 605 of classifying packets begins at a step 609 in which a traffic management arrangement obtains packets from a system onboard a vehicle. The system onboard the vehicle may generally be any suitable system including, but not limited to including, sensor systems, compute systems, diagnostic systems, navigation systems, power systems, communications systems, and/or propulsion systems.

FIG. 6 is a process flow diagram which illustrates a method of classifying packets using a traffic management arrangement onboard a vehicle in accordance with an embodiment. A method 605 of classifying packets begins at a step 609 in which a traffic management arrangement obtains packets from a system onboard a vehicle. The system onboard the vehicle may generally be any suitable system including, but not limited to including, sensor systems, compute systems, diagnostic systems, navigation systems, power systems, communications systems, and/or propulsion systems.

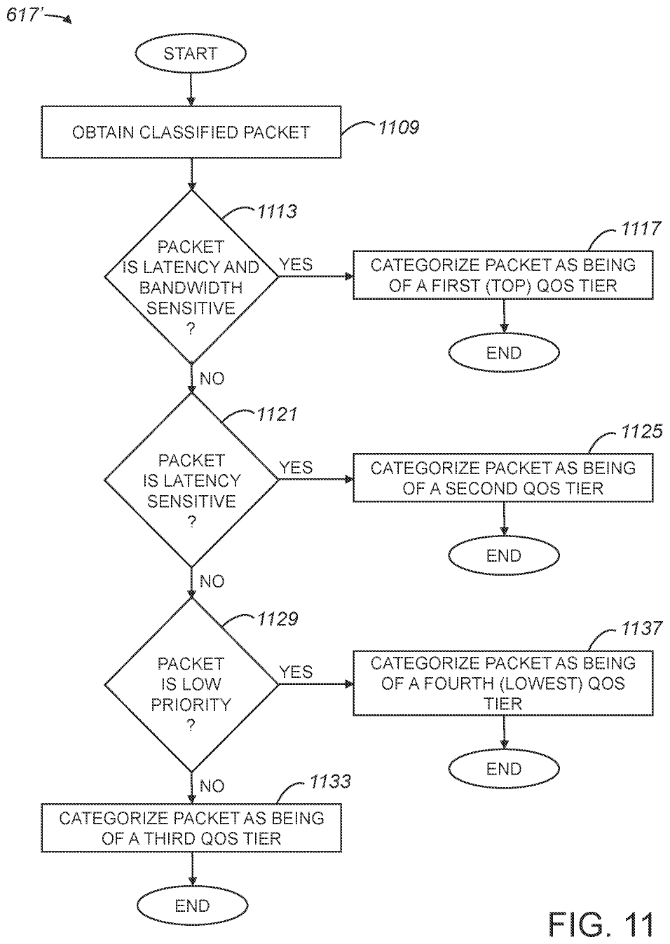

Once the packets are classified, the QoS tiers associated with each of the classified packets are identified using the traffic management arrangement in a step 617. That is, the classified packets may effectively be grouped based on priorities for transmission by a modem arrangement to an external system via a network. One example of a method of identifying QoS tiers associated with classified packets will be discussed below with reference to FIG. 11.

After the QoS tiers are identified for the classified packets, process flow moves to a step 621 in which information is provided to essentially identify the tier associated with each classified packet. Providing information to identify an associated tier may include, but is not limited to including, marking each classified packet with a mark that identifies the associated tier. By way of example, a differentiated services code points (DSCP) field of an outgoing classified packet, or a classified IP packet, may be set to identify a QoS tier. Setting the DSCP fields of outgoing classified packets may include setting the DSCP fields using service classes, e.g., services classes defined in Configuration Guidelines for DiffServ Service Classes (RFC 4594). Setting the DSCP fields of classified packets effectively enables a per-packet specification of a QoS tier. In one embodiment, cgroups may additionally, or alternatively, be used to specify QoS tiers.

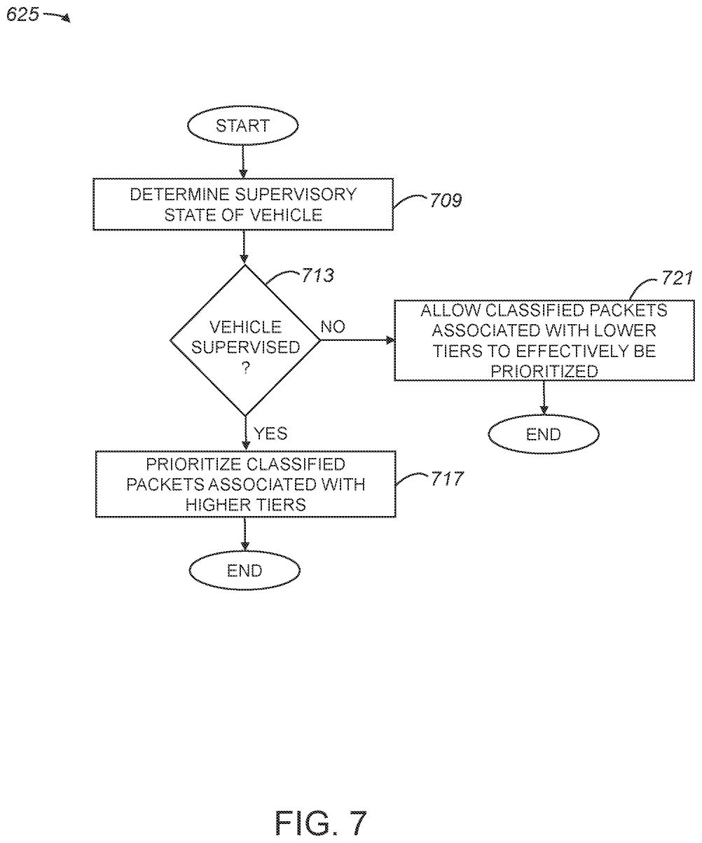

From step 621, process flow proceeds to a step 625 in which the classified packets are provided to a modem arrangement based on the identified tiers. Typically, when there are higher priority classified packets to be transmitted or otherwise provided to a network, the higher priority classified packets may be prioritized. In one embodiment, when a vehicle is in a state where there are essentially no higher priority classified packets to offload from a vehicle, lower priority classified packets may effectively be prioritized. One method of providing classified packets to a modem arrangement will be discussed below with reference to FIG. 7. Upon providing the classified packets to a modem arrangement, the method of classifying packets using a traffic management arrangement is completed.

Referring next to FIG. 7, a method of providing classified packets to a modem arrangement based on tiers, e.g., step 625 of FIG. 6, will be described in accordance with an embodiment. Method 625 of providing classified packets to a modem arrangement begins at a step 709 in which a supervisory state of the vehicle which includes the modem arrangement is determined. The supervisory state of the vehicle is an indication of whether the vehicle is in a state of substantially active supervision, e.g., whether the vehicle is being operated by or observed by a teleoperations system, That is, the vehicle may be considered to be under supervision when a teleoperations system or similar system is monitoring the operation of the vehicle or actively controlling the operation of the vehicle.

A determination is made in step 713 as to whether the vehicle is supervised. If the determination is that the vehicle is supervised, the indication is that higher priority data such as data used by a teleoperations system to monitor and/or to remotely operate the vehicle is contained in classified packets. Accordingly, in a step 717, the classified packets associated with higher tiers is prioritized for transmission or delivery to an external system, e.g., a teleoperations system. The method of providing classified traffic to a modem arrangement is completed upon prioritizing the classified packets.

Alternatively, if it is determined in step 713 that the vehicle is not supervised, the implication is that the vehicle is operating substantially independently, e.g., autonomously, and not under the supervision of a teleoperations system. That is, if it is determined that the vehicle is not supervised, the vehicle is generally not currently being monitored by or operated by a teleoperations system. As such, process flow moves from step 713 to a step 721 in which the classified packets associated with lower tiers are effectively prioritized. In other words, when there are effectively no classified packets associated with higher tiers to be prioritized for transmission, the classified packets associated with lower tiers essentially become prioritized tiers for transmissions. By way of example, if there is effectively no video data to be transmitted to a teleoperations system, then log data may essentially be prioritized for transmission. After classified packets associated with lower tiers are effectively prioritized, the method of providing classified traffic to a modem arrangement is completed.

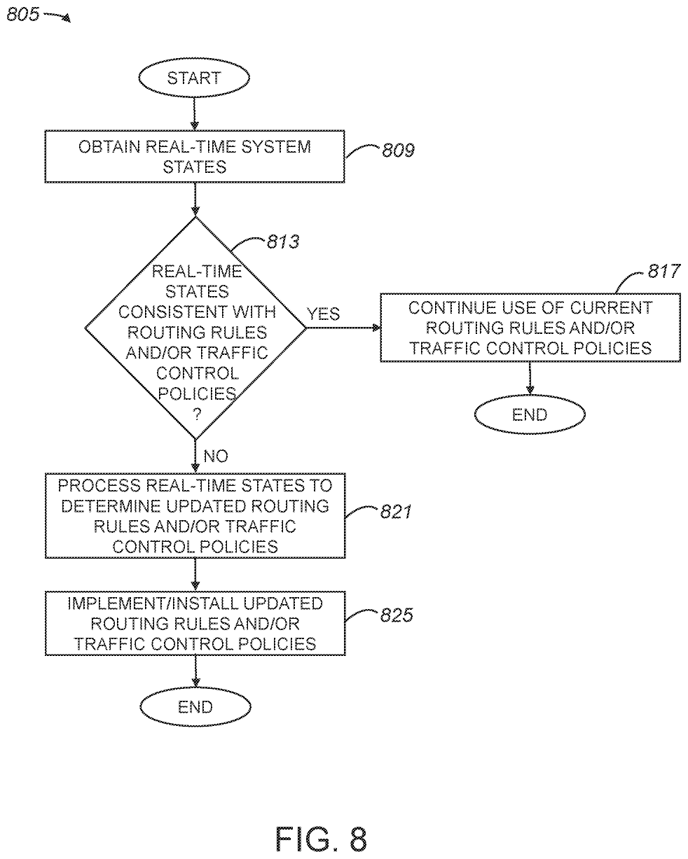

Rules and policies associated with a traffic management arrangement may be updated, as for example updated substantially in real-time. Communication channels associated with modems may have performance variations depending on factors including, but not limited to including, time and geolocations. FIG. 8 is a process flow diagram which illustrates a method of operating a policy daemon that may be part of a packet intelligence and distribution arrangement, e.g., patent intelligence and distribution arrangement 452 of FIG. 4, in accordance with an embodiment. A method 805 of operating a policy daemon begins at a step 809 in which the policy daemon obtains one or more real-time states from systems onboard a vehicle. Real-time states may include, but are not limited to including, system states, drive-by-wire states, and network metrics.

In a step 813, it is determined whether the real-time states are consistent with current routing rules and/or current traffic control policies of a traffic management arrangement. In other words, a determination is made as to whether the current routing rules and/or traffic control policies are to be updated in view of real-time states.

If it is determined in step 813 that the real-time states are consistent with current routing rules and/or current traffic control policies, then the current routing rules and/or traffic control policies continue to be used in a step 817, and the method of operating a policy daemon is completed. Alternatively, if the determination is that the real-time states are not consistent with routing rules and/or traffic control policies, then process flow proceeds to a step 821 in which the real-time states are processed to determine updated routing rules and/or traffic control policies.

The updated routing rules and/or traffic control polices may include QoS policies that are pre-defined for each QoS tier such that substantially the same configuration may address various network conditions across substantially all modems included in a modem arrangement. Pre-defined QoS policies may be installed on an operating system of a vehicle, and updating the QoS policies may include selecting an appropriate QoS policy given the real-time states. On the other hand, updating routing rules and/or traffic control policies may be dynamically generated and installed as network conditions change and/or based on real-time states.

Once updated routing rules and/or traffic control policies being determined or otherwise generated in step 813, the updated routing rules and/or traffic control policies are implemented or installed with respect to the traffic management arrangement in a step 825. Upon the updated routing rules and/or traffic control policies being implemented, the method of operating a policy daemon is completed.

The use of QoS tiers may be substantially enforced using any suitable method. In one embodiment, a traffic control subsystem may be used to substantially enforce QoS tiers. A hierarchy of queuing disciplines may be identified, and classified packets provided to modems may be managed per interface. Per-interface policies may be augmented using global constraints that may effectively be enforced using an intermediate queueing device. It should be appreciated that for different QoS tiers, queuing disciplines may be used to effectively guarantee a substantially minimum bandwidth and to essentially enforce rate limits.

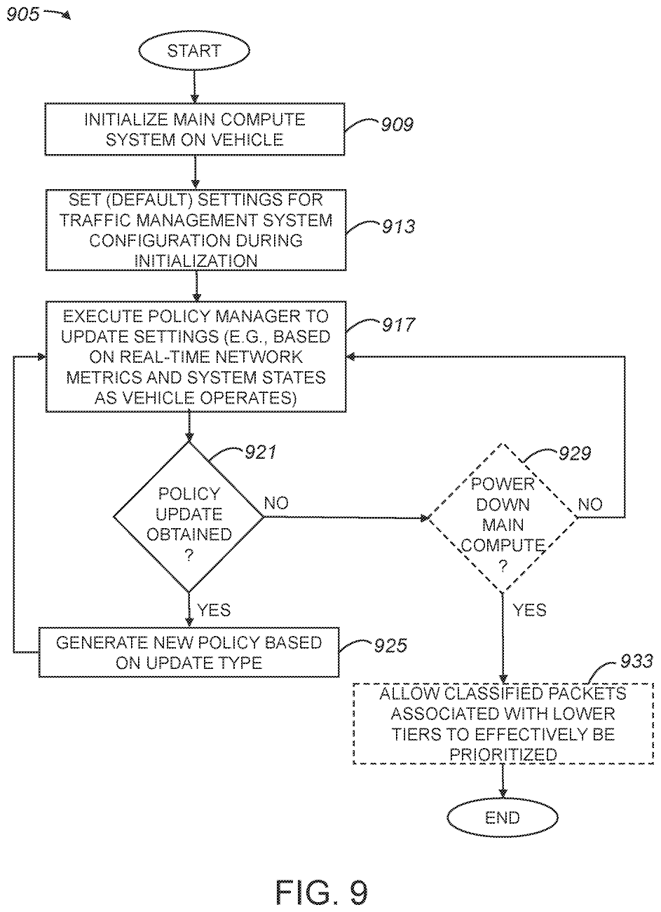

In general, when a vehicle is powered on or otherwise started, policies associated with a traffic management system of the vehicle may be initialized with respect to the vehicle. The policies may then be updated as appropriate while the vehicle operates. FIG. 9 is a process flow diagram which illustrates a method of configuring a traffic management system of a vehicle in accordance with an embodiment. A method 905 of configuring a traffic management system on a vehicle begins at a step 909 in which a computing system on a vehicle, e.g., a main compute, is initialized.

Settings, as for example default settings, may be set for the traffic management system in a step 913 when the computing system is initialized. In other words, the traffic management system is configured with default settings during initialization of a main compute. Default settings may be applied during a bootup, e.g., a Linux system bootup the main compute. Default settings may include, but are not limited to including, policies and parameters associated with network conditions and/or modem performance being as expected, and rates and/or ceilings for QoS tiers. In general, default settings may be permissive to essentially avoid throttling of traffic when throttling is not beneficial, not otherwise desired, and/or not expected to be needed.

In a step 917, as the vehicle operates, a policy manager on the vehicle executes to update settings based on real-time network metrics and system states associated with the vehicle. That is, the vehicle collects information relating to a network and information relating to system states of the vehicle, and uses the collected information to update settings for the traffic management system.

A determination is made in a step 921 as to whether a policy update is obtained. A policy update, e.g., an update with respect to one or more telemetries, may be provided to the vehicle from offboard the vehicle, and may be sent or otherwise provided to the vehicle with a relatively high priority when a teleoperation session is either not available or not started. A policy update may include, but is not limited to including, bandwidth allocated to each QoS tier, ceiling values for each QoS tier, a policy update type including a reason for triggering the policy update, and/or rules for rerouting packets from degraded modems to one or more non-degraded modems if modem degradation is detected. When a teleoperation session is started, the priority of a policy update associated with a telemetry may be a lower priority. If it is determined in step 921 that a policy update has been obtained, then a new policy is generated based on an update type associated with the policy update in a step 925. The vehicle may detect updates associated with services, for example, and may determine new policies including, but not limited to including, traffic priorities and/or bandwidth allocations, during run time to substantially accommodate new or updated traffic requirements. From step 925, process flow returns to step 917 in which the policy manager executes to update settings. It should be appreciated that executing the policy manager may cause the policy associated with the policy manager to be updated with the new policy generated in step 925.

Alternatively, if it is determined in step 921 that a policy update has not been obtained, then it is determined in an optional step 929 whether the main compute is to be powered down. That is, it may be determined whether the vehicle is to at least temporarily stop operating. If it is determined that the main compute is not to be powered down, process flow returns to step 917 in which the policy manager continues to execute. It should be appreciated that when optional step 929 is not executed, process flow may move from step 921 to step 917 when it is determined that a policy update has not been obtained.

On the other hand, if it is determined that the main compute is to be powered down, then classified packets associated with lower tiers, e.g., lower QoS tiers, may effectively be prioritized for transmission in an optional step 933. The method of configuring a traffic management system is completed after classified packets associated with lower tiers are effectively prioritized.

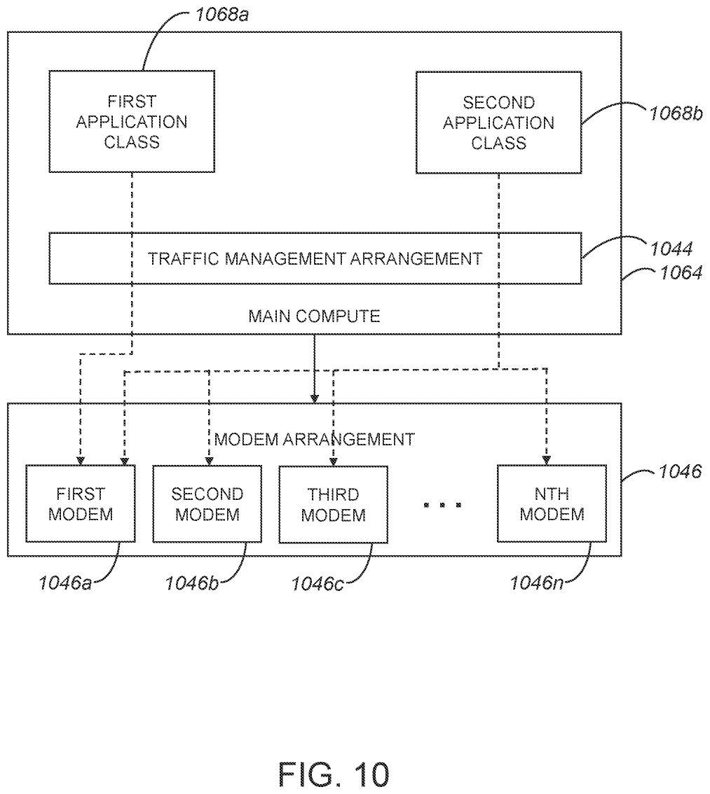

Referring next to FIG. 10, a main compute of a vehicle that includes a traffic management system will be discussed in accordance with an embodiment. A main compute 1064 generally includes hardware and/or software logic that includes a traffic management arrangement 1044. Main compute 1064 communicates with a modem arrangement 1046 which is also onboard a vehicle. Modem arrangement 1046 generally includes at least one modem 1046a-n. While each modem 1046a-n may be included on a separate component of a vehicle, e.g., each modem 1046a-n may be on a separate camera aggregator component or board, it should be appreciated that more than one modem 1046a-n may be included on a shared component. A camera aggregator or “cameragator” is generally configured to combine or otherwise aggregate video streams, preprocess video streams, and provide video streams to appropriate systems on the vehicle.

Applications 1068a, 1068b may be hosted by main compute 1064. In one embodiment, applications of a first application class or type 1068a utilize a particular modem 1046a-n, e.g., first modem 1046a. In one embodiment, first modem 1046a may be a default modem used by applications of a first application class 1068a. Applications of a second application class or type 1068b may generally use any of modems 1046a-n. It should be appreciated that applications 1068a, 1068b on a vehicle are generally mostly applications of the first application class 1068a and, thus, are essentially configured to attempt to utilize a particular modem 1046a-n when possible.

In general, the number of QoS tiers that classified packets may be associated with may vary widely. Additionally, the characteristics of the QoS tiers may also vary widely. In one embodiment, a traffic management system may have approximately four QoS tiers, and the approximately four QoS tiers may each have a substantially default, or standard, priority level. FIG. 11 is a process flow diagram which illustrates a method of grouping or categorizing packets into one of four QoS tiers, e.g., step 617 of FIG. 6, in accordance with an embodiment. A method 617′ of grouping or categorizing packets into one of four QoS tiers begins at a step 1109 in which a classified packet is obtained.

Once the classified packet is obtained, a determination is made in a step 1113 as to whether the packet is latency and bandwidth sensitive. In other words, it is determined whether the type of traffic carried in the packet has a relatively low tolerance for both latency issues and bandwidth issues. A packet may be classified as being latency and bandwidth sensitive when the packet contains traffic or information that is considered to be relatively critical to the safe operation of an autonomous vehicle. For example, a packet that contains video or other information that is to be provided to a teleoperations system may be considered to be critical to the ability of an autonomous vehicle to operate safely. If it is determined that the packet is latency and bandwidth sensitive, then the packet is identified as, or categorized as, being of a first or top QoS tier in a step 1117, and the method of grouping or categorizing packets into one of four QoS tiers is completed.

Alternatively, if it is determined in step 1113 that the packet is not latency and bandwidth sensitive, process flow proceeds to a step 1121 in which it is determined whether the packet is latency sensitive. A packet that is latency sensitive, but is generally not bandwidth sensitive, may contain information telemetry information or messages. If the determination is that the packet is latency sensitive, the packet is categorized in a step 1125 as being of a second QoS tier. The second QoS tier has a lower default priority than the first or top QoS tier. After the packet is categorized as being of the second QoS tier, the method of grouping or categorizing packets into one of four QoS tiers is completed.

On the other hand, if it is determined in step 1121 that the packet is not latency sensitive, then a determination is made in a step 1129 as to whether the packet is classified as being of a relatively low default priority. A relatively low priority packet may be a packet that contains information that is not critical to the safe operation of a vehicle. In one embodiment, a relatively low priority packet may be a packet that contains a snapshot of, or is otherwise associated with, a vehicle log or record.

If it is determined in step 1129 that the packet is not of a relatively low priority, the implication is that the packet is of a “default” default priority. That is, the indication is that the packet is not considered to be of a relatively high priority or a relatively low priority. Traffic that may be considered to be of a default priority includes, but is not limited to including, traffic that includes metrics about the state and events associated with a vehicle that are collected for monitoring and analytics but are not sensitive to latency, and messages transmitted from onboard applications to offboard services to indicate the health or data freshness of the onboard applications. Accordingly, process flow proceeds to a step 1133 in which the packet is categorized as being of a third QoS tier, and the method of grouping or categorizing packets into one of four QoS tiers is completed. Alternatively, if it is determined in step 1129 that the packet is of a relatively low priority, the packet is categorized as being of a fourth, or lowest, QoS tier in a step 1137, and the method of grouping or categorizing packets into one of four QoS tiers is completed.

Although only a few embodiments have been described in this disclosure, it should be understood that the disclosure may be embodied in many other specific forms without departing from the spirit or the scope of the present disclosure. By way of example, while the use of a traffic management arrangement has been described as being suitable for use on a vehicle to manage egress traffic or traffic being provided by the vehicle to a network, the traffic management arrangement may also be used to manage ingress traffic to the vehicle. In addition, a traffic management arrangement is not limited to being implemented on a vehicle.

The enforcement of QoS tiers may be accomplished using a traffic control subsystem, as discussed above. One other method for enforcing QoS tiers may involve intercepting substantially all packets either via a kernel module or in a user space and providing the intercepted packets to a centralized decision arrangement which may reorder, delay, and/or route packets across different modems. A method for enforcing QoS tiers may also involve enabling applications or systems to provide packets with substantially built-in rate-limiting QoS tiers which may each have different quotas for egress rates.

Typically, lower-priority traffic may be allocated additional bandwidth when there is a relatively low amount of higher-priority traffic. It should be appreciated however, that lower-priority traffic is not limited to being provided with additional bandwidth allocation substantially only when there is a relatively low amount of higher-priority traffic. For instance, a QoS tier with a lower priority may be prioritized for transmission before a QoS tier with a higher priority in some situations.

The types of traffic, e.g., signals and/or packets, may vary widely. In general, any data that may be exchanged between a vehicle and a network may be classified and, further, prioritized for delivery. That is, the types of data that may be classified and associated with a tier for transmission on a network are not limited to those discussed above.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

In general, while an autonomous vehicle has been described as being arranged to transport goods, it should be appreciated that an autonomous vehicle may additionally, or alternatively, be configured to transport passengers. That is, an autonomous vehicle is not limited to transporting goods.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. In addition, a traffic management arrangement may include software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method of classifying packets comprising:
obtaining at least a first packet on a traffic management arrangement, the traffic management arrangement being implemented on a vehicle, the vehicle including a modem arrangement that includes at least a first modem, wherein obtaining the first packet includes obtaining the first packet from a system onboard the vehicle;
classifying the first packet using the traffic management arrangement, wherein classifying the first packet creates a first classified packet;
identifying a first quality of service (QoS) tier of a plurality of QoS tiers for the first classified packet;
providing the first classified packet with information that identifies the first QoS tier; and
providing the first classified packet to the modem arrangement for transmission to a network based on the first QoS tier.

2. The method of claim 1 further including:
obtaining a second packet on the traffic management arrangement;
classifying the second packet using the traffic management arrangement, wherein classifying the second packet creates a second classified packet;
identifying a second QoS tier of the plurality of QoS tiers for the second classified packet; and
providing the second classified packet with information that identifies the second QoS tier.

3. An apparatus comprising:
providing the second classified packet to the modem arrangement based on the second QoS tier, wherein providing the first classified packet to the modem arrangement based on the first QoS tier includes providing the first classified packet to the modem arrangement after providing the second classified packet to the modem arrangement when the second QoS tier has a higher priority for transmission than the first QoS tier, and wherein providing the first classified packet to the modem arrangement based on the first QoS tier includes providing the first classified packet to the modem arrangement before providing the second classified packet to the modem arrangement when the first QoS tier has the higher priority for transmission than the second QoS tier.

4. The method of claim 3 wherein the first QoS tier is a higher tier than the second QoS tier, the method further including:
determining a state of the vehicle; and
determining whether to prioritize the first QoS tier or the second QoS tier for transmission based on the state of the vehicle.

5. The method of claim 4 wherein determining the state of the vehicle includes determining whether the vehicle is in a supervisory control state, wherein when the vehicle is in the supervisory control state, the first QoS tier is prioritized over the second QoS tier for transmission.

6. The method of claim 4 wherein determining the state of the vehicle includes determining whether the vehicle is under a supervisory control state, wherein when the vehicle is not in the supervisory control state, the second QoS tier is prioritized over the second QoS tier for transmission.

7. The method of claim 2 wherein the first modem includes a plurality of traffic interfaces, the plurality of traffic interfaces including a first tier traffic interface and a second tier traffic interface, and wherein providing the first classified packet to the modem arrangement includes providing the first classified packet to the first tier traffic interface of the first modem, the method further including:
providing the second classified packet to the second tier traffic interface of the first modem.

8. A vehicle comprising:
a chassis;
a modem arrangement carried on the chassis, the modem arrangement being configured to enable the vehicle to communicate with a network, the modem arrangement including a plurality of modems;
at least a first system carried on the chassis; and
a traffic management arrangement carried on the chassis, the traffic management arrangement including logic encoded in one or more tangible non-transitory, computer-readable media for execution and when executed operable to
obtain at least a first packet from the first system,
classify the first packet to create a first classified packet,
identify a first quality of service (QoS) tier of a plurality of QoS tiers for the first classified packet,
provide the first classified packet with information that identifies the first QoS tier; and
provide the first classified packet to the modem arrangement for transmission to the network based on the first QoS tier.

9. The vehicle of claim 8 further including a second system, wherein the logic is further operable to:
obtain a second packet from the second system;
classify the second packet to create a second classified packet;
identify a second QoS tier of the plurality of QoS tiers for the second classified packet; and
provide the second classified packet with information that identifies the second QoS tier.

10. The vehicle of claim 9 wherein the logic is further operable to:
provide the second classified packet to the modem arrangement based on the second QoS tier, wherein the logic operable to provide the first classified packet to the modem arrangement based on the first QoS tier is operable to provide the first classified packet to the modem arrangement after providing the second classified packet to the modem arrangement when the second QoS tier has a higher priority for transmission than the first QoS tier, and wherein the logic operable to provide the first classified packet to the modem arrangement based on the first QoS tier is operable to provide the first classified packet to the modem arrangement before providing the second classified packet to the modem arrangement when the first QoS tier has the higher priority for transmission than the second QoS tier.

11. The vehicle of claim 10 wherein the first QoS tier is a higher tier than the second QoS tier, and wherein the logic is further operable to:
determine a state of the vehicle; and
determine whether to prioritize the first QoS tier or the second QoS tier for transmission based on the state of the vehicle.

12. The vehicle of claim 11 wherein the logic operable to determine the state of the vehicle is further operable to determine whether the vehicle is in a supervisory control state, wherein when the vehicle is in the supervisory control state, the first QoS tier is prioritized over the second QoS tier for transmission.

13. The vehicle of claim 11 wherein the logic operable to determine the state of the vehicle is further operable to determine whether the vehicle is under a supervisory control state, wherein when the vehicle is not in the supervisory control state, the second QoS tier is prioritized over the second QoS tier for transmission.

14. The vehicle of claim 9 wherein the first modem includes a plurality of traffic interfaces, the plurality of traffic interfaces including a first tier traffic interface and a second tier traffic interface, and wherein the logic operable to provide the first classified packet to the modem arrangement is further operable to provide the first classified packet to the first tier traffic interface of the first modem.

15. The vehicle of claim 14 wherein the logic is further operable to:
provide the second classified packet to the second tier traffic interface of the first modem.

16. A vehicle comprising:
a chassis;
a modem arrangement carried on the chassis, the modem arrangement including a plurality of modems, wherein the modem arrangement is configured to communicate with a network;
a plurality of systems, the plurality of systems including a first system, the first system configured to provide a first packet of data; and
a traffic management arrangement carried on the chassis, wherein the traffic management arrangement includes
a packet intelligence and distribution arrangement arranged to obtain the first packet of data from the first system and to identify contents of the first packet of data to enable the first packet of data to be prioritized for distribution by the modem arrangement,
a real-time state arrangement arranged to identify a state of the vehicle,
a routing rule arrangement arranged to update at least one routing rule for the vehicle based on the state, and
a traffic control policy arrangement arranged to update at least one traffic control policy for the vehicle based on the state, wherein the routing rule and the traffic control policy determine how the first packet of data is to be provided to the modem arrangement for distribution.

17. The vehicle of claim 16 wherein the packet intelligence and distribution arrangement includes a classification arrangement, the classification arrangement being configured to identify a first Quality of Service (QoS) tier of a plurality of QoS tiers for the first packet of data.

18. The vehicle of claim 17 wherein the plurality of modems includes at least a first modem and a second modem, the first modem including a plurality of traffic interfaces, the plurality of traffic interfaces including a first traffic interface associated with the first QoS tier.

19. The vehicle of claim 16 wherein the state is a supervisory state of the vehicle, the supervisory state of the vehicle being one selected from a group including an unsupervised state and a supervised state, wherein the vehicle is in the supervised state when the vehicle is monitored by a teleoperations system.

20. The vehicle of claim 16 wherein the traffic management system includes logic encoded in one or more tangible non-transitory computer-readable media for execution.
